(19) United States
(12) Patent Application Publication
(10) Pub. No.: US 2004/0077316 A1
(43) Pub. Date: Apr. 22, 2004

(54) Use of power detection to control RX/TX switching

(76) Inventor: Wei Xiong, San Diego, CA (US)

Correspondence Address: Qualcomm Incorporated, Patents Department, 5775 Morehouse Drive, San Diego, CA, 92121-1714, US

(21) Appl. No.: 10/299,539

(22) Filed: Nov. 18, 2002

Related U.S. Application Data
(60) Provisional application No. 60/419,296, filed on Oct. 16, 2002.

(51) Int. Cl. H04B 1/38; H04B 1/44

(52) U.S. Cl. 455/78; 455/73

(57) ABSTRACT

A system for RX/TX switching of a transmitter and receiver includes a power detector that converts the transmit power level of the transmitter to a detector voltage. The system also includes a comparator that compares the detector voltage to a reference voltage and outputs a control signal to an RX/TX switch that is controlled by the control signal and switches an antenna connection between the transmitter and the receiver. A method for RX/TX switching includes providing a reference voltage corresponding to a desired transmit power level. The method also includes comparing the reference voltage to a detector voltage corresponding to a transmit power level of the transmitter. The method includes controlling an RX/TX switch as a result of the comparison so that the RX/TX switch switches an antenna connection between the transmitter and the receiver, thereby providing half-duplex operation of the transmitter and receiver.

### BACKGROUND OF THE INVENTION

The present invention generally relates to wireless communication devices and, more particularly, to half-duplex operation of wireless transmitter-receivers for communication between a wireless device and an access point in a local area network (LAN).

Wireless communication devices, for example devices using radio frequency signal transmission, generally must comply with regulations limiting, for example, the radio frequency emissions, transmit power, and mode of operation of the devices. Such regulations may be enforced by the Federal Communications Commission (FCC) in the United States, for example, or in Europe by the European Telecommunications Standards Institute (ETSI). Wireless LAN communication networks are subject, for example, to the 802.11 standard, which includes, for example, 802.11a, 802.11b, and 802.11g standards. For example, the 802.11b standard limits transmit power for wireless LAN communication devices in the United States to 30 decibels relative to one milliwatt (dBm), in Europe, to 20 dBm, and in Japan, to 10 dBm per megaHertz (dBm/MHz). Such wireless LAN communication devices may be described as stations or access points. Stations typically may be found in laptop computers, cell phones, portable modems, or personal digital assistants (PDAs), where they are used for communication with a wired LAN through an access point, which may be generally described as a wireless transmitter/receiver connected into the wired LAN for interfacing the wired LAN to the wireless communication devices. Stations may also communicate with other stations in a peer-to-peer network, without the presence of an access point, described in the 802.11 standard as “ad-hoc” mode.

The 802.11 standard specifies a half-duplex mode of operation for wireless transmitter-receivers, also commonly referred to as “transceivers”, included in wireless LAN communication devices. Half-duplex operation is characterized by the transceiver, at any given time, either transmitting a signal or receiving a signal, but not both. Half-duplex operation is distinguished from full-duplex operation in which the transceiver may simultaneously transmit one signal while receiving a second signal. Half-duplex operation typically requires control by the communication device as to whether the transmitter or the receiver is either operating or has access to the communication channel. As illustrated by FIG. 1, for example, control over access to the communication channel may be accomplished by switching the connection of the antenna of the wireless communication device between the receiver and the transmitter of the device.

FIG. 1 shows an example of wireless LAN communication device 100. Communication device 100 includes receive-transmit (RX/TX) switch 102 for switching the connection of antenna 104 of wireless communication device 100 between receiver 106 and transmitter 108 of device 100. Control over RX/TX switch 102 may be provided by control signal 110 so that, for example, if control signal 110 is “high”, RX/TX switch 102 may connect antenna 104 to transmitter 108, referred to as “transmit position”, so that transmit signal 112 is passed from transmitter 108 to antenna 104. Continuing the same example, if control signal 110 is “low”, RX/TX switch 102 may connect antenna 104 to receiver 106, referred to as “receive position”, so that receive signal 114 is passed from antenna 104 to receiver 106.

Control signal 110 typically, in the prior art, is provided by a modulator/demodulator (modem), such as modem 116, which may also include a capability for performing digital processing. Modem 116 is typically implemented on an integrated circuit (IC) chip. Modem 116 may perform several functions including, for example, processing baseband receive signal 118 from receiver 106 and providing baseband transmit signal 120 to transmitter 108. Modem 116 may also process digital signal 122 provided by analog-to-digital converter (ADC) 124. ADC 124 may convert detector voltage 126 to digital signal 122 so that that the digital value of digital signal 122 corresponds proportionately to the analog value of detector voltage 126. Detector voltage 126 may be provided by power detector 128. Power detector 128 may comprise, for example, a diode detector and appropriate circuitry for converting the power level of transmit signal 112 to detector voltage 126.

The value of digital signal 122 corresponding to detector voltage 126 may be used as input by modem 116 for performing various functions. For example, modem 116 may use digital signal 122 as feedback for controlling the transmit power level of wireless LAN communication device 100 according to the 802.11 standard as noted above. Also, for example, modem 116 may use digital signal 122 for determining whether RX/TX switch 102 should be switched to transmit position or receive position and accordingly provide either a high or low value for control signal 110.

There is an inherent time delay between the sensing of power output of transmit signal 112 by power detector 128 and changing control signal 110 when modem 116 provides control signal 110 using digital signal 122. For example, some delay may be caused by the circuitry of ADC 124, and further delay may be caused by modem 116 itself in processing digital signal 122 and making a decision whether to switch RX/TX switch 102. Reduction of any unnecessary time delays has the advantage of increasing communication speed and data throughput of wireless LAN communication device 100. In addition, providing control signal 110 from modem 116 typically requires an RX/TX control signal pin on the IC chip used to implement modem 116. Simplifying the design of IC chips by either reducing the number of pins or using the available pins only for the most necessary functions generally has the advantage of reducing design complexity and complexity of circuit board connections, leading to lower cost and more reliable implementations. In addition, using modem 116 as the control for RX/TX switch 102 incurs hardware and software complexity in modem 116.

As can be seen, there is a need for control of RX/TX switching for half-duplex operation of wireless communication devices, in which the control of RX/TX switching avoids certain time delays. There is also a need for control of RX/TX switching of wireless communication devices, which eliminates the need for a control signal pin for RX/TX switching from the modem IC chip. Furthermore, there is also a need to simplify the hardware and software complexity of modem 116. It is desirable that the decision to switch the RX/TX switch 102 is made automatically and transparent to modem 116.

### SUMMARY OF THE INVENTION

In one aspect of the present invention, a system for RX/TX switching of a transmitter and receiver includes a power detector that converts the transmit power level of the transmitter to a detector voltage. The system also includes a comparator that compares the detector voltage to a reference voltage and outputs a control signal to an RX/TX switch that is controlled by the control signal and switches an antenna connection between the transmitter and the receiver.

In another aspect of the present invention, a transmitter-receiver includes a transmitter that transmits a transmit signal having a power level, and a receiver that receives a receive signal. The transmitter-receiver also includes a power detector that converts the power level of the transmit signal to a detector voltage, a comparator that compares the detector voltage to a reference voltage and outputs a control signal, and an RX/TX switch that is connected to the transmitter and connected to the receiver. The RX/TX switch is controlled by the control signal, and switches an antenna connection between the transmitter and the receiver, thereby providing half-duplex operation of the transmitter-receiver.

In still another aspect of the present invention, a wireless communication device includes a transmitter that transmits a transmit signal having a power level; a receiver that receives a receive signal; and a power detector that converts the power level of the transmit signal to a detector voltage. The wireless communication device also includes a comparator having two inputs. The comparator compares the detector voltage to a reference voltage and provides a control signal. The detector voltage is connected to the first input of the comparator; the reference voltage is connected to the second input of the comparator; the comparator provides a high value for the control signal when the detector voltage is greater than the reference voltage; and the comparator provides a low value for the control signal when the detector voltage is less than the reference voltage. An RX/TX switch is connected to the transmitter and the receiver. The RX/TX switch is controlled by the control signal so that the RX/TX switch switches an antenna connection to the transmitter when the control signal has the high value, and the RX/TX switch switches the antenna connection to the receiver when the control signal has the low value, thereby providing half-duplex operation of the wireless communication device.

In yet another aspect of the present invention, a wireless local area network includes at least one wireless LAN communication device in communication with the wireless local area network. The at least one wireless LAN communication device includes a transmitter that transmits a transmit signal having a power level; a receiver that receives a receive signal; a power detector that converts the power level of the transmit signal to a detector voltage; and a comparator having two inputs. The comparator compares the detector voltage to a reference voltage and provides a control signal. The detector voltage is connected to the first input of the comparator; the reference voltage is connected to the second input of the comparator; the comparator provides a high value for the control signal when the detector voltage is greater than the reference voltage; and the comparator provides a low value for the control signal when the detector voltage is less than the reference voltage. An RX/TX switch is connected to the transmitter and the receiver. The RX/TX switch is controlled by the control signal, so that the RX/TX switch switches an antenna connection to the transmitter when the control signal has the high value, and the RX/TX switch switches the antenna connection to the receiver when the control signal has the low value, thereby providing half-duplex operation of the wireless LAN communication device.

In a further aspect of the present invention, a method for RX/TX switching includes providing a reference voltage corresponding to a desired transmit power level. The method also includes comparing the reference voltage to a detector voltage corresponding to a transmit power level of a transmitter. The method further includes controlling an RX/TX switch as a result of the comparison so that the RX/TX switch switches an antenna connection between the transmitter and a receiver, thereby providing half-duplex operation of the transmitter and receiver.

In a still further aspect of the present invention, a method for half-duplex operation of a wireless LAN communication device includes providing a reference voltage corresponding to a desired transmit power level and comparing the reference voltage to a detector voltage corresponding to a transmit power level of a transmitter. The method also includes providing a control signal to an RX/TX switch, the control signal being used to switch the RX/TX switch to connect an antenna to the transmitter when the detector voltage is greater than the reference voltage and to connect the antenna to a receiver when the detector voltage is less than the reference voltage, thereby providing half-duplex operation of the transmitter and receiver in the wireless LAN communication device.

These and other features, aspects and advantages of the present invention will become better understood with reference to the following drawings, description and claims.

### BRIEF DESCRIPTION OF THE DRAWINGS

FIG. 1 is a block diagram of one example of a prior art wireless communication device that operates in half-duplex mode;

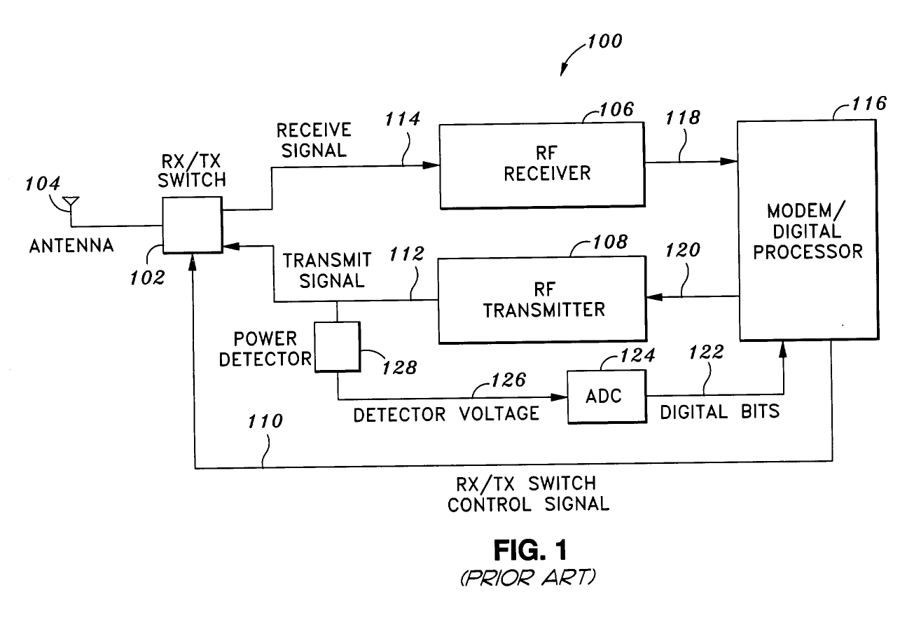

FIG. 2 is a diagram of a wireless LAN, having access to a wired LAN, in accordance with an embodiment of the present invention;

FIG. 3 is a block diagram of an exemplary wireless communication device according to one embodiment of the present invention; and

FIG. 4 is a block diagram of an exemplary wireless communication device according to another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

One embodiment of the present invention provides for control of receive-transmit (RX/TX) switching for half-duplex operation of wireless communication devices, in which the control of RX/TX switching avoids certain time delays common in the prior art, such as time delays associated with conversion of the transmit power level from analog to digital and time delays associated with digital processing of a control signal to effect the RX/TX switching. Such time delays are avoided in one embodiment of the present invention by providing an RX/TX switching control signal by direct comparison of transmitter power level to a reference voltage, rather than, as in the prior art, providing the control signal from a digital processor after converting the transmit power level to a digital value for use by the digital processor.

In one embodiment, the present invention also provides control of RX/TX switching of a wireless communication device in which the need for a control signal pin for RX/TX switching is eliminated from the modem integrated circuit (IC) chip, as compared to prior art RX/TX switching requiring such a control signal pin on the modem IC chip. The need for the pin may be eliminated as a result of using the direct comparison just described rather than the prior art approach of providing control from the digital processor of the modem IC chip.

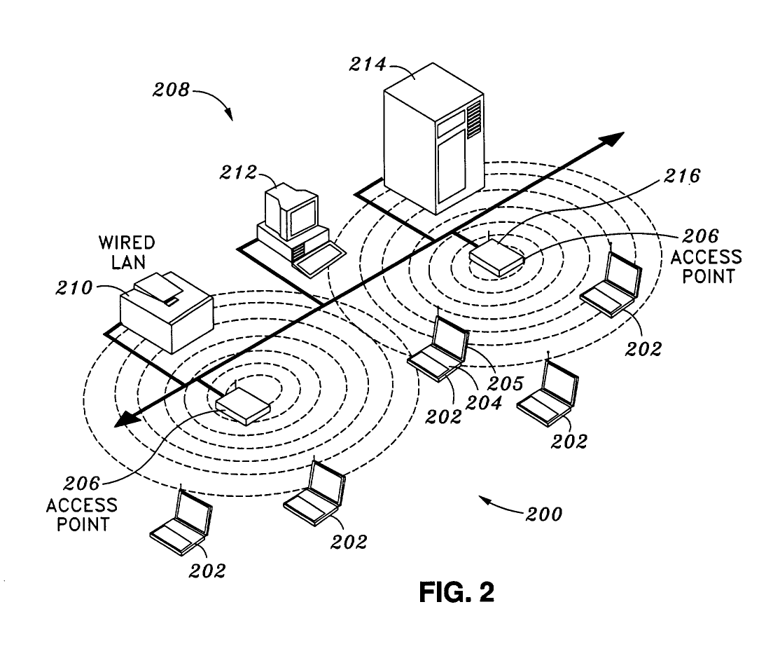

One example of wireless communication devices that could benefit from application of the present invention is wireless local area network (LAN) communication devices that may typically be found in laptop computers, cell phones, portable modems, or personal digital assistants (PDAs), where they are used for communication in a wireless LAN subject to the 802.11 standard or for communication with a wired LAN through an access point subject to the 802.11 standard. For example, FIG. 2 shows a wireless LAN 200 comprising wireless communication devices 202, where at least one of the wireless communication devices 202, for example, wireless communication device 204, includes RX/TX switching according to an embodiment of the present invention as more fully described below. As illustrated in FIG. 2, communication device 204 may be included in a laptop computer 205, for example, providing wireless communication between laptop computer 205 and wireless LAN 200. One or more of communication devices, for example, laptop computer 205, may include RX/TX switching according to an embodiment of the present invention.

Wireless LAN 200 may operate in ad hoc mode, as described above, so that, for example, wireless communication devices 202 operate in a peer-to-peer network, without the presence of an access point, or wireless LAN 200 may be connected through one or more access points 206 to a wired LAN 208. Access points 206, for example, may provide wireless communication according to the 802.11 standard between wireless LAN 200 and wired LAN 208. Wired LAN 208 may be used, for example, to connect various devices, such as network printer 210, personal computer 212, and file server 214 as known in the art. Wired LAN 208 may also be used, for example, to connect the various devices, such as network printer 210, personal computer 212, and file server 214, to access points 206 and thereby to wireless LAN 200. One or more of access points, for example, access point 216, may include RX/TX switching according to an embodiment of the present invention.

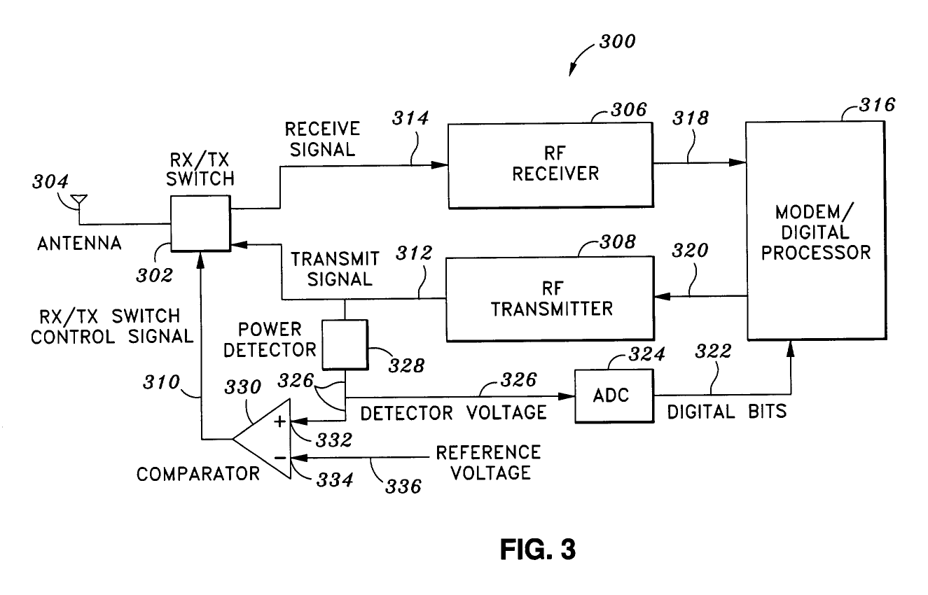

Referring now to FIG. 3, an exemplary wireless LAN communication device 300 according to one embodiment is illustrated. Communication device 300 may include RX/TX switch 302 for switching the connection of antenna 304 of wireless communication device 300 between receiver 306 and transmitter 308 of device 300 to provide half-duplex operation, which may be in compliance with various standards and regulations, such as the 802.11 standard. RX/TX switch 302 may be implemented, for example, using transistor circuitry as known in the art. Control over RX/TX switch 302 may be provided by control signal 310 so that, for example, if control signal 310 is “high”, RX/TX switch 302 may connect antenna 304 to transmitter 308, referred to as “transmit position”, so that transmit signal 312 is passed from transmitter 308 to antenna 304. Continuing the same example, if control signal 310 is “low”, RX/TX switch 302 may connect antenna 304 to receiver 306, referred to as “receive position”, so that receive signal 314 is passed from antenna 304 to receiver 306.

Communication device 300 may include a modulator/demodulator (modem), such as modem 316, which may also include a capability for performing digital processing. Modem 316 may be implemented, for example, on an IC chip. Modem 316 may perform several functions including, for example, processing baseband receive signal 318 from receiver 306 and providing baseband transmit signal 320 to transmitter 308. Modem 316 may also process digital signal 322 provided by analog-to-digital converter (ADC) 324. ADC 324 may convert detector voltage 326 to digital signal 322 so that the digital value of digital signal 322 corresponds proportionately to the analog value of detector voltage 326. Detector voltage 326 may be provided by power detector 328. Power detector 328 may comprise, for example, a diode detector and appropriate circuitry for converting the power level of transmit signal 312, also referred to as “transmit power level”, to detector voltage 326. The value of digital signal 322 corresponding to detector voltage 326 may be used as input by modem 316 for performing various functions. For example, modem 316 may use digital signal 322 as feedback for controlling the transmit power level of wireless LAN communication device 300 according to the 802.11 standard as noted above.

Control signal 310 may be provided by comparator 330. Comparator 330 may be implemented, for example, using a differential amplifier, as known in the art. Comparator 330 may, for example, provide a high value for control signal 310 when voltage at plus input 332 of comparator 330 is greater than voltage at minus input 334 of comparator 330, and a low value for control signal 310 when voltage at plus input 332 of comparator 330 is less than voltage at minus input 334 of comparator 330. As shown in FIG. 3, detector voltage 326 may be connected to plus input 332 of comparator 330, and a reference voltage 336 may be connected to minus input 334 of comparator 330. The value of reference voltage 336 may be pre-determined as that value of detector voltage 326 corresponding to the power level of transmit signal 312 above which it is desired to switch RX/TX switch 302 to the transmit position. The particular value of reference voltage 336 chosen thus may depend on the characteristics of power detector 328 as well as the desired transmit power level, as can be appreciated by a person of ordinary skill in the art. The particular value of reference voltage 336 chosen may be provided, for example, by a resistor ladder, also known as a voltage divider, as known in the art. The particular value of reference voltage 336 chosen may also be provided, for example, by a voltage source such as, for example, a power supply regulator or, for example, a transistor circuit.

Thus, according to the example illustrated in FIG. 3, when the transmit power level of transmitter 308 is above the desired level, detector voltage 326 at plus input 332 may be greater than reference voltage 336 at minus input 334 so that output of comparator 330, i.e. control signal 310, may be high, and RX/TX switch 302 may switch to the transmit position so that transmit signal 312 may be connected to antenna 304. Also, according to the example illustrated in FIG. 3, when the transmit power level of transmitter 308 is below the desired level, detector voltage 326 at plus input 332 may be less than reference voltage 336 at minus input 334 so that output of comparator 330, i.e. control signal 310, may be low, and RX/TX switch 302 may switch to the receive position so that receive signal 314 may be connected to antenna 304. The example of FIG. 3 may illustrate the use of “high” logic. As understood by a person of ordinary skill in the art, “low” logic may also be used. Thus, RX/TX switching may be accomplished directly without intervention or time delays by modem 316. In addition, because no switch control signal connection to modem 316 may be needed, no switch control signal pin is needed for an IC implementation of modem 316.

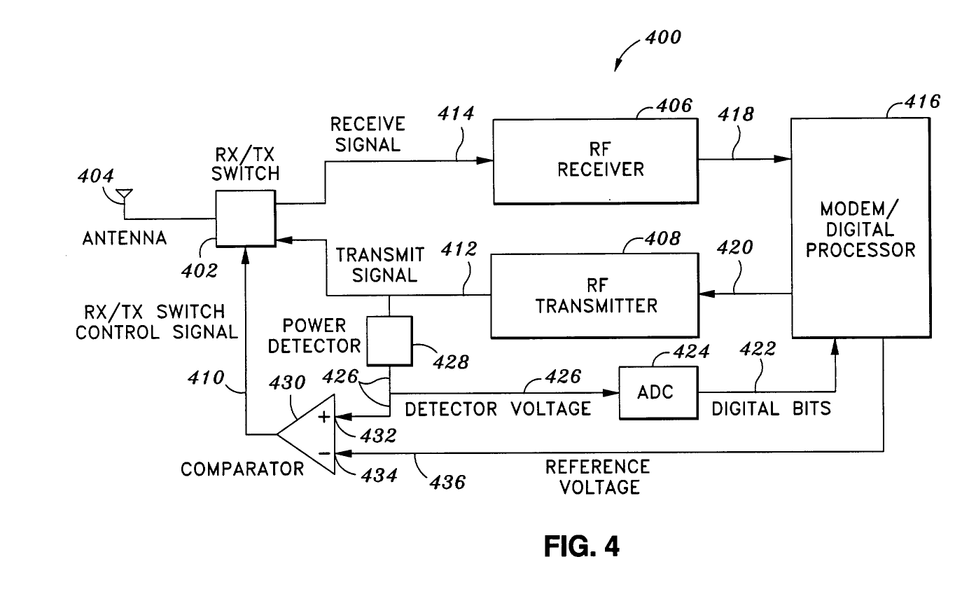

Referring now to FIG. 4, an exemplary wireless LAN communication device 400 according to an alternative embodiment is illustrated. In the embodiment shown in FIG. 4, reference voltage 436 is shown as being provided by a connection to modem 416, whereas the reference voltage 336 shown in FIG. 3 may be provided at a pre-determined value from a constant source, for example, from a resistor voltage divider network. Thus, the embodiment shown in FIG. 4 may provide dynamic adjustment of reference voltage 436 by modem 416 during operation of communication device 400. Communication device 400 may include RX/TX switch 402 for switching the connection of antenna 404 of wireless communication device 400 between receiver 406 and transmitter 408 of device 400 to provide half-duplex operation, which may be in compliance with various standards and regulations, such as the 802.11 standard. RX/TX switch 402 may be implemented, for example, using transistor circuitry as known in the art. Control over RX/TX switch 402 may be provided by control signal 410 so that, for example, if control signal 410 is “high”, RX/TX switch 402 may connect antenna 404 to transmitter 408, referred to as “transmit position”, so that transmit signal 412 is passed from transmitter 408 to antenna 404. Continuing the same example, if control signal 410 is “low”, RX/TX switch 402 may connect antenna 404 to receiver 406, referred to as “receive position”, so that receive signal 414 is passed from antenna 404 to receiver 406.

Communication device 400 may include a modem, such as modem 416, which may also include a capability for performing digital processing. Modem 416 may be implemented, for example, on an IC chip. Modem 416 may perform several functions including, for example, processing baseband receive signal 418 from receiver 406 and providing baseband transmit signal 420 to transmitter 408. Modem 416 may also process digital signal 422 provided by ADC 424. ADC 424 may convert detector voltage 426 to digital signal 422 so that that the digital value of digital signal 422 corresponds proportionately to the analog value of detector voltage 426. Detector voltage 426 may be provided by power detector 428. Power detector 428 may comprise, for example, a diode detector and appropriate circuitry for converting the power level of transmit signal 412, also referred to as “transmit power level”, to detector voltage 426. The value of digital signal 422 corresponding to detector voltage 426 may be used as input by modem 416 for performing various functions. For example, modem 416 may use digital signal 422 as feedback for controlling the transmit power level of wireless LAN communication device 400 according to the 802.11 standard as noted above.

Control signal 410 may be provided by comparator 430. Comparator 430 may be implemented, for example, using a differential amplifier, as known in the art. Comparator 430 may, for example, provide a high value for control signal 410 when voltage at plus input 432 of comparator 430 is greater than voltage at minus input 434 of comparator 430, and a low value for control signal 410 when voltage at plus input 432 of comparator 430 is less than voltage at minus input 434 of comparator 430. As shown in FIG. 4, detector voltage 426 may be connected to plus input 432 of comparator 430 and a reference voltage 436 may be connected to minus input 434 of comparator 430. As seen in FIG. 4, reference voltage 436 may be provided by modem 416. The value of reference voltage 436 may be set by modem 416 as that value of detector voltage 426 corresponding to the power level of transmit signal 412 above which it is desired to switch RX/TX switch 402 to the transmit position. The range of particular values of reference voltage 436 set by modem 416 thus may depend on the characteristics of power detector 428 as well as the desired range of transmit power levels, as can be appreciated by a person of ordinary skill in the art. Thus, the exemplary embodiment illustrated in FIG. 4 provides flexibility for wireless communication device 400 by allowing modem 416 to set, from time to time, the desired power level at which RX/TX switching takes place.

Thus, according to the example illustrated in FIG. 4, when the transmit power level of transmitter 408 is above a desired level, detector voltage 426 at plus input 432 may be greater than reference voltage 436 at minus input 434 so that output of comparator 430, i.e. control signal 410, may be high, and RX/TX switch 402 may switch to the transmit position so that transmit signal 412 may be connected to antenna 404. Also, according to the example illustrated in FIG. 4, when the transmit power level of transmitter 408 is below a desired level, detector voltage 426 at plus input 432 may be less than reference voltage 436 at minus input 434 so that output of comparator 430, i.e. control signal 410, may be low, and RX/TX switch 402 may switch to the receive position so that receive signal 414 may be connected to antenna 404. The example of FIG. 4 may illustrate the use of “high” logic. As understood by a person of ordinary skill in the art, “low” logic may also be used. Thus, RX/TX switching may be accomplished directly without intervention or time delays by modem 416, yet the desired power level at which RX/TX switching occurs may be set by modem 416.

According to one embodiment of the present invention, a method for RX/TX switching for providing half-duplex operation of a wireless LAN communication device, such as wireless LAN communication device 300 or 400, may include determining a reference voltage, such as reference voltage 336, or using a modem digital processor, such as modem 416 to set a reference voltage, such as reference voltage 436, to correspond to a desired transmit power level, such as a desired value of the power level of transmit signal 312. The method may include comparing the reference voltage to a detector voltage, such as detector voltage 326, provided by a power detector, such as power detector 328, which provides a detector voltage corresponding to the transmit power level. For example, detector voltage 326 may be provided proportional to the power level of transmit signal 312. The comparison may be made, for example using a differential amplifier, such as comparator 330. The method may further include providing a control signal, such as control signal 310, as a result of the comparison. The control signal may be used, for example, to switch an RX/TX switch, such as RX/TX switch 302, to a transmit position, for example, connecting antenna 304 to transmitter 308, when the detector voltage is greater than the reference voltage and to a receive position, for example, connecting antenna 304 to receiver 306, when the detector voltage is less than the reference voltage, thus providing half-duplex operation of the transmitter and receiver in the communication device, such as transmitter 308 and receiver 306 of wireless LAN communication device 300.

It should be understood, of course, that the foregoing relates to preferred embodiments of the invention and that modifications may be made without departing from the spirit and scope of the invention as set forth in the following claims.

We claim:

1. A system for RX/TX switching of a transmitter and receiver, comprising:
a power detector that converts a transmit power level of said transmitter to a detector voltage;
a comparator that compares said detector voltage to a reference voltage and outputs a control signal; and
an RX/TX switch that is controlled by said control signal and that switches an antenna connection between said transmitter and said receiver.

2. The system of claim 1 wherein:
said detector voltage is connected to a first input of said comparator;
said reference voltage is connected to a second input of said comparator;
said comparator provides a first value for said control signal when said detector voltage is greater than said reference voltage; and
said comparator provides a second value for said control signal when said detector voltage is less than said reference voltage.

3. The system of claim 2 wherein:
said RX/TX switch switches said antenna connection to said transmitter when said control signal has said first value; and
said RX/TX switch switches said antenna connection to said receiver when said control signal has said second value.

4. The system of claim 1 wherein a value of said reference voltage is pre-determined as equal to a value of said detector voltage corresponding to a desired transmit power level.

5. The system of claim 1 wherein a value of said reference voltage is set by a modem and is set as equal to a value of said detector voltage corresponding to a desired transmit power level.

6. The system of claim 1 wherein said RX/TX switching is in accordance with an 802.11 standard.

7. A transmitter-receiver comprising:
a transmitter that transmits a transmit signal, said transmit signal having a power level;
a receiver that receives a receive signal;
a power detector that converts said power level of said transmit signal to a detector voltage;
a comparator that compares said detector voltage to a reference voltage and outputs a control signal; and
an RX/TX switch that is connected to said transmitter and connected to said receiver, that is controlled by said control signal, and that switches an antenna connection between said transmitter and said receiver, thereby providing half-duplex operation of said transmitter-receiver.

8. The transmitter-receiver of claim 7 wherein:
said detector voltage is connected to a first input of said comparator;
said reference voltage is connected to a second input of said comparator;
said comparator provides a first value for said control signal when said detector voltage is greater than said reference voltage;
said comparator provides a second value for said control signal when said detector voltage is less than said reference voltage;
said RX/TX switch switches said antenna connection to said transmitter when said control signal has said first value; and
said RX/TX switch switches said antenna connection to said receiver when said control signal has said second value.

9. The transmitter-receiver of claim 7 wherein said reference voltage is provided by a resistor voltage divider network at a pre-determined value equal to a value of said detector voltage corresponding to a desired transmit power level.

10. The transmitter-receiver of claim 7 wherein said reference voltage is set by a modem during operation of said transmitter-receiver to a value of said detector voltage corresponding to a desired transmit power level.

11. The transmitter-receiver of claim 7 wherein said half-duplex operation is in accordance with an 802.11 standard.

12. A wireless communication device comprising:
a transmitter that transmits a transmit signal, said transmit signal having a power level;
a receiver that receives a receive signal;
a power detector that converts said power level of said transmit signal to a detector voltage;
a comparator having a first input and a second input wherein:
said comparator compares said detector voltage to a reference voltage and provides a control signal;
said detector voltage is connected to said first input of said comparator;
said reference voltage is connected to said second input of said comparator;
said comparator provides a first value for said control signal when said detector voltage is greater than said reference voltage; and
said comparator provides a second value for said control signal when said detector voltage is less than said reference voltage; and
an RX/TX switch that is connected to said transmitter and connected to said receiver wherein
said RX/TX switch is controlled by said control signal;
said RX/TX switch switches an antenna connection to said transmitter when said control signal has said first value; and
said RX/TX switch switches said antenna connection to said receiver when said control signal has said second value, thereby providing half-duplex operation of said wireless communication device.

13. The wireless communication device of claim 12 wherein said reference voltage is provided by a resistor voltage divider network at a pre-determined value equal to a value of said detector voltage output by said power detector when said transmitter transmits at a desired transmit power level.

14. The wireless communication device of claim 12 wherein said reference voltage is provided by a voltage source at a pre-determined value equal to a value of said detector voltage output by said power detector when said transmitter transmits at a desired transmit power level.

15. The wireless communication device of claim 12 wherein said reference voltage is set by a modem during operation of said transmitter-receiver to a value of said detector voltage output by said power detector when said transmitter transmits at a desired transmit power level.

16. The wireless communication device of claim 12 wherein said comparator comprises a differential amplifier.

17. The wireless communication device of claim 12 wherein said half-duplex operation is in accordance with an 802.11 standard.

18. A wireless local area network comprising:
a first wireless LAN communication device; and
a second wireless LAN communication device in communication with said first wireless LAN communication device, wherein said second wireless LAN communication device comprises:
a transmitter that transmits a transmit signal, said transmit signal having a power level;
a receiver that receives a receive signal;
a power detector that converts said power level of said transmit signal to a detector voltage;
a comparator having a first input and a second input wherein;
said comparator compares said detector voltage to a reference voltage and provides a control signal;
said detector voltage is connected to said first input of said comparator;
said reference voltage is connected to said second input of said comparator;
said comparator provides a first value for said control signal when said detector voltage is greater than said reference voltage; and
said comparator provides a second value for said control signal when said detector voltage is less than said reference voltage; and
an RX/TX switch that is connected to said transmitter and connected to said receiver wherein:
said RX/TX switch is controlled by said control signal;
said RX/TX switch switches an antenna connection to said transmitter when said control signal has said first value; and
said RX/TX switch switches said antenna connection to said receiver when said control signal has said second value, thereby providing half-duplex operation of said second wireless LAN communication device.

19. The wireless local area network of claim 18, further comprising a wired local area network; wherein said second wireless LAN communication device communicates with said wired local area network via an access point.

20. The wireless local area network of claim 18 wherein:
said power detector comprises a power detector diode; and
said power detector converts said power level of said transmit signal to said detector voltage so that a value of said detector voltage corresponds proportionally to a value of said power level.

21. The wireless local area network of claim 18 wherein:
said power detector comprises a power detector diode;
said reference voltage is provided by a voltage source at a pre-determined value of said reference voltage equal to a value of said detector voltage output by said power detector diode when said transmitter transmits at a desired transmit power level; and
said desired power level is in accordance with an 802.11 standard.

22. The wireless local area network of claim 18 wherein:
said power detector comprises a power detector diode;
said reference voltage is set by a modem during operation of said transmitter-receiver and is set to a value equal to said detector voltage output by said power detector diode when said transmitter transmits at a desired transmit power level; and
said desired power level is in accordance with an 802.11 standard.

23. The wireless communication device of claim 18 wherein said comparator comprises a differential amplifier and said first input is a plus input and said second input is a minus input.

24. The wireless local area network of claim 18 wherein said half-duplex operation is in accordance with an 802.11 standard.

25. A method for RX/TX switching comprising:
providing a reference voltage corresponding to a desired transmit power level;
comparing said reference voltage to a detector voltage corresponding to a transmit power level of a transmitter; and
controlling an RX/TX switch as a result of said comparing wherein said RX/TX switch switches an antenna connection between said transmitter and a receiver, thereby providing half-duplex operation of said transmitter and receiver.

26. The method of claim 25 further comprising a step of providing a control signal to said RX/TX switch, said control signal being used to switch said RX/TX switch to connect an antenna to said transmitter when said detector voltage is greater than said reference voltage and to connect said antenna to said receiver when said detector voltage is less than said reference voltage.

27. The method of claim 25 further comprising a step of pre-determining said reference voltage as equal to a value of said detector voltage corresponding to said desired transmit power level.

28. The method of claim 25 further comprising a step of setting said reference voltage, using a modem digital processor, as equal to a value of said detector voltage corresponding to said desired transmit power level.

29. The method of claim 25 wherein said RX/TX switching is in accordance with an 802.11 standard.

30. A method for half-duplex operation of a wireless LAN communication device comprising:
providing a reference voltage corresponding to a desired transmit power level;
comparing said reference voltage to a detector voltage corresponding to a transmit power level of a transmitter; and
providing a control signal to an RX/TX switch, said control signal being used to switch said RX/TX switch to connect an antenna to said transmitter when said detector voltage is greater than said reference voltage and to connect said antenna to a receiver when said detector voltage is less than said reference voltage, thereby providing half-duplex operation of said transmitter and receiver in said wireless LAN communication device.

31. The method of claim 30 further comprising a step of providing said detector voltage from a power detector connected to said transmitter wherein said detector voltage corresponds proportionally to said transmit power level.

32. The method of claim 30 wherein said step of providing said reference voltage comprises connecting said reference voltage to a resistor voltage divider network, and said reference voltage is equal to a pre-determined value of said detector voltage corresponding to said desired transmit power level.

33. The method of claim 30 wherein said step of providing said reference voltage comprises connecting said reference voltage to a voltage source, and said reference voltage is equal to a pre-determined value of said detector voltage corresponding to said desired transmit power level.

34. The method of claim 30 wherein said step of providing said reference voltage comprises connecting said reference voltage to a modem digital processor, and said reference voltage is set by said modem digital processor to be equal to a value of said detector voltage corresponding to said desired transmit power level.

35. The method of claim 30 wherein said half-duplex operation is in accordance with an 802.11 standard.

36. A system for RX/TX switching of a transmitter and receiver, comprising:
means for converting a transmit power level of said transmitter to a detector voltage;
means for comparing said detector voltage to a reference voltage and outputting a control signal; and
means, controlled by said control signal, for switching an antenna connection between said transmitter and said receiver.

37. The system of claim 36 wherein said means for comparing said detector voltage to a reference voltage and outputting a control signal includes:
means for providing a first value for said control signal when said detector voltage is greater than said reference voltage; and
means for providing a second value for said control signal when said detector voltage is less than said reference voltage.

38. The system of claim 37 wherein said means for switching an antenna connection between said transmitter and said receiver:
switches said antenna connection to said transmitter when said control signal has said first value; and
switches said antenna connection to said receiver when said control signal has said second value.

39. The system of claim 36 further comprising means for setting a value of said reference voltage equal to a value of said detector voltage that corresponds to a desired transmit power level.

40. The system of claim 36 wherein said switching is in accordance with an 802.11 standard.
